(19) United States
(12) Patent Application Publication
(10) Pub. No.: US 2025/0042518 A1
(43) Pub. Date: Feb. 6, 2025

(54) STRUCTURES AND METHODS FOR THE TRANSPORT, INSTALLATION, AND MAINTENANCE OF AN OFFSHORE WIND TURBINE

(71) Applicant: SEATRIUM (SG) PTE. LTD., Singapore (SG)

(72) Inventors: Maya Sreedharan, Singapore (SG); Manmohan Jit Singh, Singapore (SG); Zi Xiang Gui, Singapore (SG); Rahul M. Manohar, Singapore (SG)

(21) Appl. No.: 18/717,416

(22) PCT Filed: Dec. 12, 2022
(86) PCT No.: PCT/SG2022/050902

§ 371 Date: Jun. 6, 2024

(30) Foreign Application Priority Data
Dec. 10, 2021 (SG) 10202113711W

(51) Int. Cl. B63B 35/44; B63B 21/50; B63B 27/10; B63B 39/02; B63B 73/60

(52) U.S. Cl. CPC B63B 35/44; B63B 21/50; B63B 27/10; B63B 39/02; B63B 73/60; B63B 2035/446

(57) ABSTRACT

Described herein is an offshore buoyant structure, a floating buoyant structure, and methods of loading and unloading a floatable wind turbine substructure. The offshore buoyant structure includes a split hull constructed and dimensioned in a manner to provide a long moon pool; and a floatable wind turbine substructure accommodated by the split hull and configured to receive a floating wind turbine with a portion of the floating wind turbine extending downwardly into the long moon pool such that relative motion between at least the offshore buoyant structure and the floatable wind turbine substructure or floating wind turbine when received by the floatable wind turbine substructure is minimized. The floating buoyant structure includes a split hull constructed and dimensioned in a manner to provide a long moon pool, the split hull is configured to accommodate a floatable wind turbine substructure or a floating wind turbine assembly and minimize relative motion therebetween.

The present application claims priority to Singapore patent application number 10202113711W filed on Oct. 12, 2021 titled “Method for Low Motion Installation and Maintenance of an Offshore Wind Turbine” which is incorporated by reference herein in its entirety.

### TECHNICAL FIELD

The present invention relates to structures and methods for the transport, installation, and maintenance of an offshore wind turbine.

### BACKGROUND

In the prior art, there are various installation methods of offshore floating wind turbine systems and apparatuses. Examples of existing installation methods of a floating offshore wind turbine include wet towing of a fully assembled wind turbine assembly from a quay site to the operating site or towing the floating offshore win turbine as two or more smaller components and using a large heavy lift vessel to install and assemble the components to construct the wind turbine offshore.

However, in these methods, the towing vessel and/or installation vessel move separately from the floating wind turbine assembly or its components (in other words there is relative motion between the different floating objects (the vessel and the floating wind turbine assembly or its components). This poses a problem as the towing and/or installation may be hindered or stopped during inclement weather which increases the risk of operation and the costs of installation and maintenance.

### SUMMARY

In a first aspect, there is provided an offshore buoyant structure comprising a split hull constructed and dimensioned in a manner to provide a long moon pool; and a floatable wind turbine substructure accommodated by the split hull and configured to receive a floating wind turbine with a portion of the floating wind turbine extending downwardly into the long moon pool such that relative motion between at least the offshore buoyant structure and the floatable wind turbine substructure or floating wind turbine when received by the floatable wind turbine substructure is minimized. Advantageously, with such configuration of the offshore buoyant structure, the relative motion between at least the offshore buoyant structure and the floatable wind turbine substructure and the floating wind turbine is minimized.

Preferably, the offshore buoyant structure further comprises a dynamic positioning system operable to provide station keeping and accurate positioning of the offshore buoyant structure.

Preferably, the split hull comprises a draft control mechanism to allow a draft of the split hull to be adjusted, such that when in operation, the split hull submerges to more than a draft of the floatable wind turbine substructure to allow the split hull to accommodate the floatable wind turbine substructure.

Preferably, the split hull comprises a deck and an attachment mechanism on the deck to releasably couple the floatable wind turbine substructure to the deck. As an example, the attachment mechanism may be selected from the group consisting of a deck pad, a suction device and a securing device.

Preferably, the split hull comprises a deck crane installed on the deck used for installation and/or maintenance of the floating wind turbine.

Preferably, the floatable wind turbine substructure comprises a plurality of mooring lines and a plurality of electrical cables, and wherein the long moon pool comprises a moon pool opening on a side of the split hull and space dimensioned sufficiently to ensure the plurality of mooring lines and the plurality of electrical cables are not impacted by the movement and operation of the offshore buoyant structure.

Preferably, the long moon pool is one of the following shapes: a rectangular shape, a curve shape, a circular shape, an elliptical shape, or a triangular shape.

Preferably, a length of the long moon pool is from 40% to 60% of a length of the split hull, preferably from 50% to 60% of the length of the split hull.

Preferably, the split hull is a vessel or part thereof.

In a second aspect, there is provided a structure comprising an offshore buoyant structure according to the first aspect above and a floating wind turbine received by the floatable wind turbine substructure.

Preferably, the structure acts as a single unit or a unitary structure to eliminate or minimise relative motion between the offshore buoyant structure and the floating wind turbine.

In a third aspect, there is provided a floating buoyant structure comprising a split hull constructed and dimensioned in a manner to provide a long moon pool, the split hull is configured to accommodate a floatable wind turbine substructure or a floating wind turbine assembly, wherein the floatable wind turbine substructure is configured to receive a floating wind turbine, wherein the floating wind turbine assembly comprises the floatable wind turbine substructure coupled to the floating wind turbine, wherein the split hull is configured in a manner such that when a portion of the floating wind turbine extends downwardly into the long moon pool, relative motion between the split hull and the accommodated floatable wind turbine substructure or the accommodated floating wind turbine assembly is minimized.

Preferably, the floating buoyant structure further comprises a dynamic positioning system operable to provide station keeping and accurate positioning of the floating buoyant structure.

Preferably, the floating buoyant structure further comprises a draft control mechanism to allow a draft of the split hull to be adjusted, such that when in operation, the split hull submerges to more than the draft of the floatable wind turbine substructure or the floating wind turbine assembly to allow the split hull to accommodate the floatable wind turbine substructure or the floating wind turbine assembly.

Preferably, the split hull comprises a deck and an attachment mechanism on the deck to releasably couple the floatable wind turbine substructure or the floating wind turbine assembly to the deck.

Preferably, the attachment mechanism is selected from the group consisting of a deck pad, a suction device and a securing device.

Preferably, the split hull comprises a deck crane installed on the deck used for installation and/or maintenance of the floating wind turbine.

Preferably, the floatable wind turbine substructure comprises a plurality of mooring lines and a plurality of electrical cables, and wherein the long moon pool comprises a moon pool opening on a side of the split hull and space dimensioned sufficiently to ensure the plurality of mooring lines and the plurality of electrical cables are not impacted by the movement and operation of the floating buoyant structure.

Preferably, the long moon pool is one of the following shapes: a rectangular shape, a curve shape, a circular shape, an elliptical shape, or a triangular shape.

Preferably, a length of the long moon pool is from 40% to 60% of a length of the split hull, preferably from 50% to 60% of the length of the split hull.

Preferably, the floating buoyant structure is a vessel.

In a fourth aspect, there is provided a method of loading a floatable wind turbine substructure, the method comprising:
(a) providing a split hull constructed and dimensioned in a manner to provide a long moon pool, wherein the split hull is configured to accommodate a floatable wind turbine substructure, wherein the floatable wind turbine substructure is configured to receive a floating wind turbine;
(b) lowering the split hull to submerge the split hull to below a draft of the floatable wind turbine substructure;
(c) placing the split hull below the floatable wind turbine substructure such that a portion of the floating wind turbine extends downwardly into the long moon pool;
(d) lifting the split hull to accommodate the floatable wind turbine substructure such that relative motion between the split hull and the floatable wind turbine substructure is minimized.

Preferably, lifting the split hull to accommodate the floating wind turbine substructure comprises securing the floatable wind turbine substructure to a deck of the split hull.

Preferably, lifting the split hull to accommodate the floatable wind turbine substructure allows the split hull and the floating wind turbine substructure to act as a single unit or a unitary structure to eliminate or at least minimize relative motion between the split hull and the floatable wind turbine substructure.

In a fifth aspect, there is provided a method of unloading a floatable wind turbine substructure, the method comprising:
(a) providing an offshore buoyant structure, wherein the offshore buoyant structure comprises a split hull constructed and dimensioned in a manner to provide a long moon pool; and a floatable wind turbine substructure accommodated by the split hull and configured to receive a floating wind turbine with a portion of the floating wind turbine extending downwardly into the long moon pool; and
(b) lowering the split hull to below a draft of the floatable wind turbine substructure; and
(c) decoupling the split hull from the floatable wind turbine substructure.

Preferably, the method further comprises installing and/or performing maintenance on the wind turbine assembly.

Preferably, the method in the fourth and fifth aspects further comprises operating a dynamic positioning system to provide station keeping and accurate positioning of the split hull.

Preferably, the floatable wind turbine substructure is part of a wind turbine assembly in the fourth and fifth aspects.

Advantageously, the various aspects and embodiments described herein allows removing or at least reducing relative motion between two or more floating objects and eliminates or at least reduces the potential misalignment issue due to relative motion of different floating objects. Advantageously, this allows the floatable wind turbine substructure and floating wind turbine assembly to be safely moved between locations, and to allow for efficient installation and maintenance of the floating wind turbine assembly with low risk, maximum operation efficiency and minimal downtime. Advantageously, the embodiments allow for an increasing weather envelopment for the installation/maintenance process due to the elimination of or minimize of the relative motion between the two or more floating objects.

### DETAILED DESCRIPTION

In the Figures:

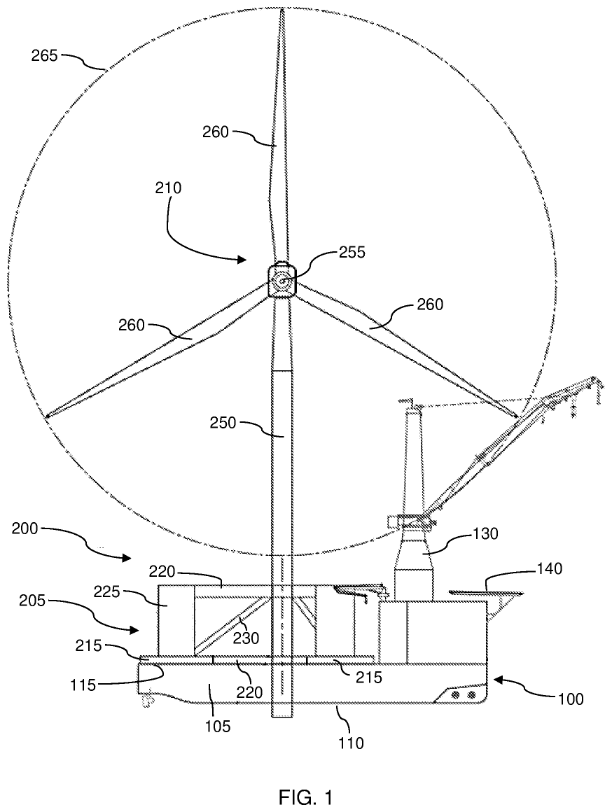

FIG. 1 illustrates the longitudinal view of an embodiment of the installation vessel and the floating wind turbine assembly; and

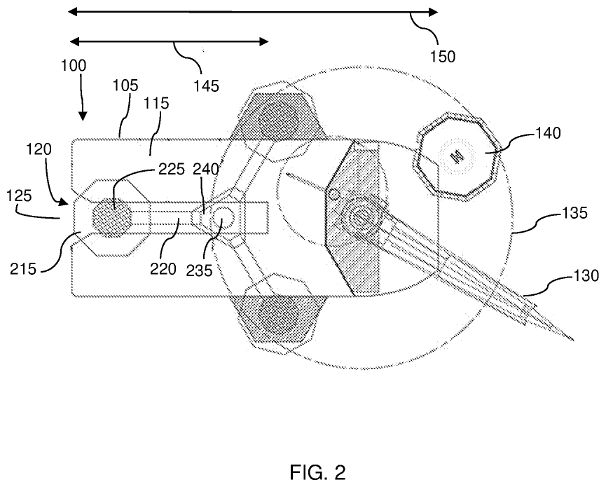

FIG. 2 illustrates the plan view from the top of FIG. 1 with the floating wind turbine omitted for clarity.

In the following description, numerous specific details are set forth in order to provide a thorough understanding of various illustrative embodiments of the invention. It will be understood, however, to one skilled in the art, that embodiments of the invention may be practiced without some or all of these specific details. Embodiments described in the context of one of the methods or devices are analogously valid for the other methods or devices. Similarly, embodiments described in the context of a method are analogously valid for a device, and vice versa.

Unless defined otherwise, all technical and scientific terms used herein have the meaning commonly understood by a person skilled in the art to which this invention belongs.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

The terms “about”, “approximately”, “substantially” must be read with reference to the context of the application as a whole, and have regard to the meaning a particular technical term qualified by such a word usually has in the field concerned. For example, it may be understood that a certain parameter, function, effect, or result can be performed or obtained within a certain tolerance, and the skilled person in the relevant technical field knows how to obtain the tolerance of such term.

The phrase “at least one of A and B” means it requires only A alone, B alone, or A and B, i.e. only one of A or B is required.

As used herein, the articles “a”, “an” and “the” as used with regard to a feature or element include a reference to one or more of the features or elements. As used herein, the term “and/or” includes any and all combinations of one or more of the associated listed items. As used herein, the terms “first,” “second,” and “third,” etc. are used merely as labels, and are not intended to impose numerical requirements on their objects. As used herein, the terms “top”, “bottom”, “left”, “right”, “side”, “vertical” and “horizontal” are used to describe relative arrangements of the elements and features. As used herein, the term “each other” denotes a reciprocal relation between two or more objects, depending on the number of objects involved.

Ranges may be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

The word “substantially” does not exclude “completely” e.g. a composition which is “substantially free” from Y may be completely free from Y. Where necessary, the word “substantially” may be omitted from the definition of the invention.

Although each of these terms has a distinct meaning, the terms “comprising”, “consisting of” and “consisting essentially of” may be interchanged for one another throughout the instant application. The term “having” has the same meaning as “comprising” and may be replaced with either the term “consisting of” or “consisting essentially of”.

Terms such as “coupled”, “connected”, “attached”, “conjugated and “linked” are used interchangeably herein and encompass direct as well as indirect connection, attachment, linkage or conjugation unless the context clearly dictates otherwise. The coupling of two components may refer to the two components being fixed, welded, or fastened directly or indirectly, removably or non-removably.

The term “structure” as used herein refers in general to an assembly or coupling of two or more parts to form a larger object.

Described herein are structures for transporting, installing and maintaining an offshore wind turbine and a transportation, installation and maintenance method for an offshore wind turbine, which improve the safety and efficiency of a Floating Offshore Wind Farm.

The embodiments described herein allows for different floating objects to act as a single unit or a unitary structure, in particular one of the floating objects may be a floating buoyant structure 100 and the other floating object is a floatable wind turbine substructure 205 or a floating wind turbine assembly 200. The floating wind turbine assembly is made up of the floatable wind turbine substructure 205 and the floating wind turbine 210. The floating wind turbine 210 may be inserted into the floatable wind turbine substructure 205 before it is accommodated by the vessel or can be inserted at the operation site. Thus, the different floating objects moves together and has no or minimal relative motion with respect to each other. This solves the problem of existing methods and systems that are has relative motion between different floating objects which poses a safety hazard and increased costs during the installation and maintenance of the floating wind turbine assembly 200.

Various embodiments may include one or more of the following features:
A split hull 105 at one end of a floating buoyant structure 100 (an example is a vessel or ship), the split hull 105 extending up to or more than half the length of the floating buoyant structure 100 creating a long moon pool 120.
A submersible method to lift up a floating wind turbine assembly 200 or a floatable wind turbine substructure 205.
Possibility to go to deep draft helps in better motion characteristics, wherein deep draft may, for example, refer to more than 60 m.
Dynamic positioning (DP) function of the floating buoyant structure 100 for station keeping and accurate positioning while lifting operation for the floating wind turbine assembly 200.
A heavy lift deck crane 130 for installation, maintenance of the components of the wind turbine assembly 200 including mast 250 for the floating wind turbine assembly 200.
A motion stabilization method.
Auto docking and auto positioning of a floating wind turbine substructure 205 of the floating wind turbine assembly 200.

This method comprises or involves a floating buoyant structure 100 (for example, a vessel) with a long moon pool 120 to accommodate a floatable wind turbine substructure 205 and mooring lines and cables of the floatable wind turbine substructure 205.

The floating buoyant structure 100 having a split hull 105 submerges to more than the draft of a floating wind turbine assembly 200 or a floatable wind turbine substructure 205. The floating buoyant structure 100 subsequently positions (by moving the structure 100) the split hull 105 below the floating wind turbine assembly 200 or the floatable wind turbine substructure 205. The split hull 105 ascends upwards and lifts up the floating wind turbine assembly 200 or the floatable wind turbine substructure 205 partially or fully for the transportation, installation and/or maintenance operations. The floating wind turbine 210 may be arranged to be received by the floatable wind turbine substructure 205. This allows two or more floating objects, for example, the floating buoyant structure 100 and the floatable wind turbine substructure 205 to act as a single unit (i.e. a unitary floating structure) and eliminate relative motion between different floating objects. An attachment mechanism, for example a deck pad, a suction device and a securing device, on the deck of the floating buoyant structure may be used to releasably couple (or secure) the floating wind turbine assembly 200, in particular the floatable wind turbine substructure 205 during and after the lifting operation. The floatable wind turbine substructure 205 (may also be termed a wind turbine platform foundation) may include mooring lines, and during the lifting operation, the mooring lines of the wind turbine platform foundation 205 would not be impacted. The floatable wind turbine substructure 205 as described herein may refer to it alone or as a part of the wind turbine assembly (i.e. a mast 250 or floating wind turbine 210 is received in the floatable wind turbine substructure).

Further to facilitate the installation/maintenance work, the floating buoyant structure 100 may include a deck crane of suitable capacity with possible heave compensation and radius of operation 135 to assist in the wind turbine assembly 200 installation/maintenance work.

An objective of the embodiments is to solve the problem faced by existing methods that are without complete solution of relative motion between different floating objects. The embodiments described herein may reduce up to 50% of the offshore installation time compared to conventional method by eliminating or minimizing the relative motion between the different floating objects.

FIG. 1 and FIG. 2 show an embodiment of the floating buoyant structure 100 (for example, a vessel or part of a vessel) and a wind turbine assembly 200 including a floatable wind turbine substructure 205 and a floating wind turbine 210.

The floating buoyant structure 100 has a split hull 105 with a long moon pool 120 which may be of any different possible shapes (e.g. rectangular, curve, circular, triangular, etc.) to accommodate a floatable wind turbine substructure 205 and any cables, and mooring lines required for the operation of the floatable wind turbine substructure 205. The split hull 105 has a deck (a top surface) 115 and a keel (a bottom surface) 110. There may be a moon pool opening 125 on one side (or end) of the split hull, for example the split hull 105 may have a general rectangular cross section when viewed from the top with two long sides (or ends and may be measured as a length of the cross-section and the substructure 205) and two short sides (and may be measured as a width of the cross-section and the substructure 205). In various embodiments, the width of the moon pool opening may be sized as required to allow the floatable wind turbine substructure 205 to be accommodated. For example, the width of the moon pool opening may be from 20% to 80% of the width of the split hull 105. In another example, the width of the moon pool opening may be from 30% to 70% of the width of the split hull 105. In another example, the width of the moon pool opening may be from 40% to 60% of the width of the split hull 105. It will be appreciated that the split hull 105 may taper downwards and may have curved edges, protrusions or grooves, but the split hull 105 may still be considered to have a generally rectangular cross section, in particular for vessels. The split hull 105 has a length 150 measured from the bow (front) to the stern (aft), and a width across the spilt hull as viewed in FIG. 2. In an embodiment, the moon pool opening 125 is preferably placed at one of the short side or edge to allow the moon pool 120 to be placed parallel, generally parallel, or substantially parallel to the long side of the rectangular cross-section. This allows the length 145 of the moon pool 120 to be at least half of the length 150 of the split hull 105, and may be termed a long moon pool 120. The length 145 of the moon pool 120 may preferably be from 40% to 60% of the length 150 of the split hull 105, more preferably from 50% to 60% of the length 150 of the split hull 105. The long moon pool 120 provides sufficient space to accommodate the floatable wind turbine substructure 205. In some examples depending on the specific requirements, the length 145 of the moon pool may be less than 40% of the length 150 of the split hull 105. For example, the length 145 of the moon pool may be from 20% to 40% of the length 150 of the split hull 105. In an embodiment, the split hull 105 may have two long longitudinal sections and a short horizontal section joining the two longitudinal sections at one end. The moon pool opening 125t may be located at the other end of the longitudinal sections, and opposite of the short horizontal section. In an embodiment, the split hull 105 has a U-shaped cross section when viewed from the top as seen in FIG. 2.

The floatable wind turbine substructure 205 has an orifice 235 (or channel) to receive a mast (may also be termed a tower) 250 of a floating wind turbine 210. The floating buoyant structure 100 and the floatable wind turbine substructure 205 when coupled together may be termed an offshore buoyant structure and may be used to transport the floatable wind turbine substructure to an operation site of the wind turbine assembly 200 where the floating wind turbine 210 may be inserted on site.

The floatable wind turbine substructure 205 and the floating wind turbine 210 together form the wind turbine assembly 200 that may be positioned offshore as an (or part of an) offshore wind farm. Thus, the split hull 105 is configured to accommodate a floatable wind turbine substructure 205 alone or as part of a floating wind turbine assembly 200 which may include part or whole of the floating wind turbine 210, for example only the mast 250 instead of the whole floating wind turbine 210.

A portion of the mast 250 of the floating wind turbine 210 when received in the floatable wind turbine substructure 205 extends beyond the lower deck of the floatable wind turbine substructure 205 and into the moon pool 120 when the floatable wind turbine substructure 205 is accommodated on the split hull 105, for example mounted on the deck 115 of the floating buoyant structure 100. The split hull 105 is configured such that when a portion of the floating wind turbine 210 (specifically the mast 250) extends downwardly into the long moon pool 120, the relative motion between the different floating objects are minimized or eliminated. For example, between the offshore buoyant structure and the floating wind turbine 210, between the split hull 105 and the floatable wind turbine substructure 205, and between the split hull 105 and the wind turbine assembly 200 when present.

The floating buoyant structure 100 may have a dynamic positioning system operable to provide station keeping and accurate positioning of the floating buoyant structure 100. The dynamic positioning system may include control systems to monitor and control propellers and thrusters to adjust the speed and heading of the floating buoyant structure. Sensors, compasses, and global position satellite (GPS) devices may be used to provide information to the control system and may be considered as part of the dynamic positioning system.

The floating buoyant structure 100 may have a draft control mechanism to allow a draft of the split hull 105 to be adjusted. This allows the draft of the split hull 105 to be adjusted to below that of the floatable wind turbine substructure 205 or wind turbine assembly 200. The dynamic positioning system allows the split hull 105 to be positioned below the floatable wind turbine substructure 205 or wind turbine assembly 200. By adjusting the draft of the split hull 105, the split hull 105 is raised up and lifts up the floatable wind turbine substructure 205 or wind turbine assembly 200, The draft control mechanism may include one or more ballast tanks that may be filled with water or air to adjust the draft of the floating buoyant structure 100. A control system may be used to fill and empty the one or more ballast tanks. One or more valves and pumps may be used in conjunction with the control system to adjust the contents of the one or more ballast tanks. The floating buoyant structure 100 may be a vessel or part of a vessel.

The deck 115 of the split hull 105 may be provided with an attachment mechanism to accommodate the floatable wind turbine substructure 205. The attachment mechanism allows the deck to be releasably coupled to the floatable wind turbine substructure 205, specifically to the bottom surface of the floatable wind turbine substructure 205. Hence, the floating buoyant structure 100 and the split hull 105 carries the floatable wind turbine substructure 205 on the deck 115. Examples of the attachment mechanism include at least one of the following: a deck pad, a suction device and a securing device. The attachment mechanism allows the split hull 105 and the floatable wind turbine substructure to be coupled securely and in a reversible manner thereby allowing the floating buoyant structure 100 and split hull 105 to load the floatable wind turbine substructure 205, transport the substructure 205 to another site and unload the substructure 205. This applies to the floatable wind turbine substructure 205 alone, or together with the mast 205, or together with the floating wind turbine 210 (i.e. the wind turbine assembly 200).

The split hull 115 may be further provided with a deck crane 130 and a helipad 140. In FIG. 2, it may be seen that the operating radius 135 of the deck crane covers the channel 235 of the floatable wind turbine substructure 205 allowing the deck crane 130 to insert the mast 250 or the floating wind turbine 210 into the floatable wind turbine substructure 205. The floatable wind turbine substructure 205 may have cables attached to it for its operation at the operation site including mooring lines and electrical cables. The floatable wind turbine substructure 205 especially the moon pool 120 is dimensioned sufficiently to ensure that the cables like mooring lines and electrical cables are not impacted by the movement and operation of the floating buoyant structure 100.

Different shapes and/or configurations of the floatable wind turbine substructure 205 from those seen in FIG. 1 and FIG. 2 may be used.

Embodiments of the wind turbine assembly 200, floatable wind turbine substructure 205 and floating wind turbine 210 are described in WO2022231511 which is incorporated by reference herein in its entirety. FIG. 1 and FIG. 2 show an embodiment of the wind turbine assembly 200 which is formed by the floatable wind turbine substructure 205 and the floating wind turbine 210.

The floatable wind turbine substructure 205 may have an upper (first) deck 240, a lower (second) deck, and a plurality of floatable substructures coupled to and around at least one of the upper deck 240 and lower deck. The upper deck 240 and lower deck are coupled to each other and arranged spaced apart from each other vertically. The coupling of the upper deck 240 and lower deck may be direct or indirect. In FIG. 2, the upper deck 240 is identical to the lower deck and overlaps each other, hence the lower deck is not visible when viewed from the top as shown in FIG. 2.

The upper deck 240 and lower deck each have a channel 235 through its deck (which are through opposing surfaces of the deck, for example from the top surface through to the bottom surface of the deck). The channels 235 are open-ended at both ends to allow the tower 250 of the wind turbine 210 to pass through the channel and decks. When deployed in the sea or other body of water, the lower deck will be submerged in the water and water is able to flow through the channel of the lower deck. The channels 235 of the upper deck 240 and lower deck are aligned to form a third continuous channel to receive at least a portion of a tower 250 of a wind turbine 210. Thus, the third channel is made up of the channels 235 of the upper deck 240, lower deck and a channel between the decks. The floatable wind turbine substructure 205 may have a central axis in the vertical direction when the buoyant structure is in use. The central axis may be in the middle of the third channel parallel to the longitudinal axis of the third channel and by necessity the channels 235 of the upper deck 240 and lower deck.

The tower 250 may be coupled to the floatable wind turbine substructure 205 by a fixation system that allows the tower 250 to be secured to the buoyant structure 100. As an example, during operating conditions of the floatable wind turbine substructure 100 with the wind turbine 210, the tower 250 may be flushed with the bottom of the lower deck. However, during installation or maintenance, the tower 250 may be displaced beyond (for example below) the buoyant structure 100 due to the lowered height of the wind turbine.

A support element may be optionally provided to directly couple the upper deck 240 and lower deck. Examples of a support element include a rod including a plurality of rods, a lattice frame, a beam and a wall. The support element is preferably arranged around the perimeter or edge of the bottom surface of the upper deck 240 and top surface of the lower deck. It will be appreciated that the top surfaces of the upper deck 240 and lower deck are relative and face in the same direction, and similarly for the bottom surfaces of the upper deck 240 and lower deck.

The floatable substructures may be coupled to at least one of the upper deck 240 and lower deck, preferably both. The floatable substructures may be arranged spaced apart from one another and around the coupled deck (either or both of the upper deck 240 and lower deck) and are preferably equidistant from each other. There are preferably at least three floatable substructures. The attachment of the plurality of floatable substructures to the upper deck 240 and/or lower deck by the connecting elements 220 allows at least the upper deck 240 of the floatable wind turbine substructure 205 to be above the water line while the lower deck may be submerged in the water when the tower 250 is received in the floatable wind turbine substructure 205. It The floatable substructures may be arranged around at least one of the upper deck 240 and lower deck in a radial manner and extends outwardly from the coupled deck. Thus, such radial coupling may be viewed as a hub and spoke with the decks as the hub and the floatable substructures as the end of the spokes.

Each floatable substructure may comprise an elongate column 225 and a pontoon 215. Preferably, either or both the elongate column 225 and pontoon 215 may have a polygonal horizontal cross-section. Advantageously, the polygonal horizontal cross-section of the elongate column 225 and pontoon 215 (i.e. bended radius of straight plate and vertices 6) provides for ease of fabrication from the constructability point of view. The elongate column 225 and pontoon 215 may each have a polygonal horizontal cross-section with vertices between the edges. The elongate column 225 and pontoon 215 may also be viewed as being polygonal in shape by virtue of its polygonal horizontal cross-section, and thus may be termed as a polygonal elongate column 225 and a polygonal pontoon 215 herein. The polygonal cross-section for both the elongate column 225 and pontoon 215 may have three or more edges, preferably three to ten edges. In an embodiment, the polygon has eight edges. Thus, the polygonal shapes that may be used include triangular, quadrilateral, pentagon, hexagon, heptagon, octagon, nonagon, decagon and so forth. The polygonal shape may be a regular polygon (in other words the angles of the polygon are equal and have all the sides have the same length). In an embodiment, the elongate column 225 has a top region and a bottom region opposite to the top region, and the pontoon 215 is coupled to the bottom region of the elongate column 225. The top region of the elongate column 225 may be coupled to the upper deck 240. The lower deck may be coupled to the pontoon 215. In an embodiment, the upper deck 240 is also coupled to the pontoon 215 by a diagonal connecting element 230. In FIG. 1, the pontoons 215 and the support element 220 may be observed to be continuous when viewed from the side in a two-dimensional plane, but it is not in a three dimensional plane.

A plurality of connecting elements 220 (i.e. an inter-connecting structure) may be provided to couple the floatable substructures to the upper deck 240 and/or lower deck. The connecting elements 220 may also indirectly couple the upper deck 240 to the lower deck. Examples of connecting elements include a rod and a beam. The connecting element 220 may be used to couple the upper deck 240 to a top region of the elongate column 225, with the bottom region of the elongate column 225 attached to the pontoon 215. The connecting element 220 may be used to couple the lower deck to the pontoon 215. A diagonal connecting element 230 may also be used to couple the upper deck 240 to the pontoon 215. The upper deck 240 and lower deck may be coupled together directly by the support element or indirectly by the connecting elements 220 and struts.

The floating wind turbine 210 includes a mast (or tower) 250, a plurality of blades 260, and a coupling joint 255 to couple the blades 260 to the mast 250. The operation radius 265 of the blades 260 is shown in FIG. 1. When transporting the floating wind turbine 210 to the operating site, the floating wind turbine 210 may be transported separately from the floatable wind turbine substructure 205. Alternatively, the floating wind turbine 210 may be transported in whole or in part with the floatable wind turbine substructure 205, for example only the mast 250 may be inserted into the channel 235 of the floatable wind turbine substructure, or the whole floating wind turbine 210 may be inserted. Advantageously, by transporting the floatable wind turbine substructure 205 and floating wind turbine 210 together as a whole, the wind turbine assembly 200 may be unloaded directly at the operation site. It may also be possible to install the wind turbine assembly 210 as a whole or part at the operation site itself, and depends on the site and operation requirements.

The split hull 105 submerges to more than the draft of a floating wind turbine assembly 200, which includes the floating wind turbine 210 and the floatable wind turbine substructure 205 that receives the floating wind turbine 210, and lifts it (i.e. the floating wind turbine assembly 200) up partially or fully for the installation/maintenance operations. This method involves both the floating buoyant structure 100 and wind turbine assembly 200 acting as a single unit to eliminate relative motion between the two floating objects. The draft of the floating wind turbine assembly 200 may be defined by a vertical distance between a waterline and a bottom end/edge of the floating wind turbine assembly 200. Deck pads, suction device and securing device on a deck 115 of the floating buoyant structure 100 secure the wind turbine assembly 200 during and after the lifting operation. During the lifting operation, the mooring lines of the wind turbine platform foundation are not impacted by the suitably dimensioned long moon pool 120 of the floating buoyant structure.

A deck crane 130, for example a heavy lift deck crane, of suitable capacity with possible heave compensation and radius of operation 135 may assist in the wind turbine installation/maintenance work.

The floatable wind turbine substructure 205 or wind turbine assembly 200 may be loaded on to the floating buoyant structure 100. This may include providing a split hull 105 or floating buoyant structure 100 as described above; lowering the split hull 105 to submerge the split hull 105 to below a draft of the floating wind turbine substructure 205 or a draft of the floating wind turbine assembly 200; placing the split hull 105 below the floating wind turbine substructure 205 or the floating wind turbine assembly 200 such that a portion of the floating wind turbine 210 extends downwardly into the long moon pool 120; and lifting the split hull 105 to accommodate the floating wind turbine substructure 205 or the floating wind turbine assembly 200, such that relative motion between the split hull 105 and the floating wind turbine substructure 205 or the floating wind turbine assembly 200 is minimized. The floatable wind turbine substructure 205 may be by itself or combined with the mast 250 of the floating wind turbine 210 or as part of the floating wind turbine assembly 200.

After the floatable wind turbine substructure 205 or wind turbine assembly 200 has been loaded and coupled to the floating buoyant structure 100, the coupled structure acts as a single unit or a unitary structure with that eliminates or minimizes the relative motion between the floating buoyant structure 100 and the floatable wind turbine substructure 205 or wind turbine assembly 200.

The coupled structure may be moved to the operation site or any other location to unload the floatable wind turbine substructure 205 or wind turbine assembly 200. The unloading may be done by lowering the split hull 105 to below a draft of the floatable wind turbine substructure 205; and decoupling the split hull from the floatable wind turbine substructure. The floatable wind turbine substructure 205 may be by itself or combined with the mast 250 of the floating wind turbine 210 or as part of the floating wind turbine assembly 200. Prior to or after the unloading, installation and/or maintenance of the wind turbine assembly 200 may be performed. For example, the installation may include any one of the following: inserting the mast 250 into the channel 235 of the floatable wind turbine substructure 205; inserting the floating wind turbine 210 into the channel 235 of the floatable wind turbine substructure 205; fixing the blades 260 to the mast 250; connecting the electrical cables; and securing the mooring lines. Maintenance of the wind turbine assembly 200 may be routine or specific maintenance to repair or replace components of the wind turbine assembly 200.

Advantageously, the installation of the components of the floating wind turbine 210 is made easy with low risk and maximum operation efficiency by the coupling of the floating buoyant structure 100 and the floatable wind turbine substructure 205.

The various embodiments may provide at least one of the following advantages:
(a) Removing or at least reducing relative motion between two or more floating objects;
(b) Eliminating or at least reducing the potential misalignment issue due to relative motion of different floating objects;
(c) Speeding up the installation/maintenance process, thereby improving efficiency;
(d) Increasing weather envelopment for installation/maintenance process.

1. An offshore buoyant structure comprising:
a split hull constructed and dimensioned in a manner to provide a long moon pool; and
a floatable wind turbine substructure accommodated by the split hull and configured to receive a floating wind turbine with a portion of the floating wind turbine extending downwardly into the long moon pool such that relative motion between at least the offshore buoyant structure and the floatable wind turbine substructure or floating wind turbine when received by the floatable wind turbine substructure is minimized.

2. The offshore buoyant structure as claimed in claim 1, further comprising a dynamic positioning system operable to provide station keeping and accurate positioning of the offshore buoyant structure.

3. The offshore buoyant structure as claimed in claim 1, wherein the split hull comprises a draft control mechanism to allow a draft of the split hull to be adjusted, such that when in operation, the split hull submerges to more than a draft of the floatable wind turbine substructure to allow the split hull to accommodate the floatable wind turbine substructure.

4. The offshore buoyant structure as claimed in claim 1, wherein the split hull comprises a deck and an attachment mechanism on the deck to releasably couple the floatable wind turbine substructure to the deck.

5. (canceled)

6. The offshore buoyant structure as claimed in claim 4, wherein the split hull comprises a deck crane installed on the deck used for installation and/or maintenance of the floating wind turbine.

7. The offshore buoyant structure as claimed in claim 1, wherein floatable wind turbine substructure comprises a plurality of mooring lines and a plurality of electrical cables, and wherein the long moon pool comprises a moon pool opening on a side of the split hull and space dimensioned sufficiently to ensure the plurality of mooring lines and the plurality of electrical cables are not impacted by the movement and operation of the offshore buoyant structure.

8. The offshore buoyant structure as claimed in, claim 1, wherein the long moon pool is one of the following shapes: a rectangular shape, a curve shape, a circular shape, an elliptical shape, or a triangular shape; and
wherein a length of the long moon pool is from 40% to 60% of a length of the split hull, preferably from 50% to 60% of the length of the split hull.

9. (canceled)

10. The offshore buoyant structure as claimed in, claim 1, wherein the split hull is a vessel or part thereof.

11. A structure comprising:
an offshore buoyant structure as claimed in claim 1; and
a floating wind turbine received by the floatable wind turbine substructure, wherein the structure acts as a single unit or a unitary structure to eliminate or minimise relative motion between the offshore buoyant structure and the floating wind turbine.

12. (canceled)

13. A floating buoyant structure comprising a split hull constructed and dimensioned in a manner to provide a long moon pool, the split hull is configured to accommodate a floatable wind turbine substructure or a floating wind turbine assembly, wherein the floatable wind turbine substructure is configured to receive a floating wind turbine, wherein the floating wind turbine assembly comprises the floatable wind turbine substructure coupled to the floating wind turbine, wherein the split hull is configured in a manner such that when a portion of the floating wind turbine extends downwardly into the long moon pool, relative motion between the split hull and the accommodated floatable wind turbine substructure or the accommodated floating wind turbine assembly is minimized.

14. The floating buoyant structure as claimed in claim 13, further comprising a dynamic positioning system operable to provide station keeping and accurate positioning of the floating buoyant structure.

15. The floating buoyant structure as claimed in claim 13, further comprising a draft control mechanism to allow a draft of the split hull to be adjusted, such that when in operation, the split hull submerges to more than the draft of the floatable wind turbine substructure or the floating wind turbine assembly to allow the split hull to accommodate the floatable wind turbine substructure or the floating wind turbine assembly.

16. The floating buoyant structure as claimed in claim 13, wherein the split hull comprises a deck and an attachment mechanism on the deck to releasably couple the floatable wind turbine substructure or the floating wind turbine assembly to the deck.

17. (canceled)

18. (canceled)

19. The floating buoyant structure as claimed in claim 13, wherein the floatable wind turbine substructure comprises a plurality of mooring lines and a plurality of electrical cables, and wherein the long moon pool comprises a moon pool opening on a side of the split hull and space dimensioned sufficiently to ensure the plurality of mooring lines and the plurality of electrical cables are not impacted by the movement and operation of the floating buoyant structure.

20. The floating buoyant structure as claimed in claim 13, wherein the long moon pool is one of the following shapes: a rectangular shape, a curve shape, a circular shape, an elliptical shape, or a triangular shape; and
wherein a length of the long moon pool is from 40% to 60% of a length of the split hull, preferably from 50% to 60% of the length of the split hull.

21. (canceled)

22. (canceled)

23. A method of loading and/or unloading a floatable wind turbine substructure, the method comprising:
for loading,
(a) providing a split hull constructed and dimensioned in a manner to provide a long moon pool, wherein the split hull is configured to accommodate the floatable wind turbine substructure, wherein the floatable wind turbine substructure is configured to receive a floating wind turbine;
(b) lowering the split hull to submerge the split hull to below a draft of the floatable wind turbine substructure;
(c) placing the split hull below the floatable wind turbine substructure such that a portion of the floating wind turbine extends downwardly into the long moon pool;
(d) lifting the split hull to accommodate the floatable wind turbine substructure such that relative motion between the split hull and the floatable wind turbine substructure is minimized; and
for unloading,
providing an offshore buoyant structure, wherein the offshore buoyant structure comprises the split hull constructed and dimensioned in a manner to provide the long moon pool; and the floatable wind turbine substructure accommodated by the split hull and configured to receive the floating wind turbine with the portion of the floating wind turbine extending downwardly into the long moon pool; and
lowering the split hull to below the draft of the floatable wind turbine substructure; and
decoupling the split hull from the floatable wind turbine substructure.

24. The method as claimed in claim 23, wherein lifting the split hull to accommodate the floating wind turbine substructure comprises securing the floatable wind turbine substructure to a deck of the split hull.

25. The method as claimed in claim 23, wherein lifting the split hull to accommodate the floatable wind turbine substructure allows the split hull and the floating wind turbine substructure to act as a single unit or a unitary structure to eliminate or at least minimize relative motion between the split hull and the floatable wind turbine substructure.

26. (canceled)

27. The method as claimed in claim 23, wherein for unloading, the method further comprising installing and/or performing maintenance on a wind turbine assembly, wherein the floatable wind turbine substructure is part of the wind turbine assembly.

28. The method as claimed in claim 23, further comprising operating a dynamic positioning system to provide station keeping and accurate positioning of the split hull.

29. (canceled)
